(19) United States
(12) Patent Application Publication
(10) Pub. No.: US 2010/0305934 A1
(43) Pub. Date: Dec. 2, 2010

(54) LOGICAL SIMULATION SYSTEM, LOGICAL SIMULATION METHOD, AND LOGICAL SIMULATION PROGRAM

(75) Inventor: Naoto KOSUGI, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU SEMICONDUCTOR LIMITED, Yokohama (JP)

(21) Appl. No.: 12/786,558

(22) Filed: May 25, 2010

(30) Foreign Application Priority Data
May 26, 2009 (JP) 2009-126783

(51) Int. Cl. G06F 17/50

(52) U.S. Cl. 703/15

(57) ABSTRACT

A program that simulates a netlist data including a plurality of basic elements using a computer includes a logic operation section configured to stipulate a logic operation of at least one of the plurality of the basic elements, a change detection section configured to detect changes in signal levels at an input-and-output end of the at least one of the plurality of the basic elements, and a data storage section configured to store a position data corresponding to the changes of the signal levels.

### CROSS-REFERENCE TO RELATED APPLICATIONS

This application claims the benefit of priority from Japanese Patent Application No. 2009-126783 filed on May 26, 2009, the entire contents of which are incorporated herein by reference.

### BACKGROUND OF THE INVENTION

1. Field

Embodiments discussed herein relate to digital data processing.

2. Description of Related Art

Since large-scale integrated (LSI) circuits have increased in size, the LSI circuits are designed in intellectual property (IP) cores. The IP core indicates a partial circuit block of the LSI circuit and information about the functional part of the LSI circuit. For example, the use of an IP core designed by a different company allows for designing an LSI circuit at low cost in a short period of time. Therefore, the circuit information is concealed, which may make it difficult to analyze the LSI circuit.

Related technologies are exemplarily disclosed in Japanese Laid-open Patent Publication No. H9-282346.

### SUMMARY

One aspect of the embodiments, a program that simulates a netlist data including a plurality of basic elements using a computer includes a logic operation section configured to stipulate a logic operation of at least one of the plurality of the basic elements; a change detection section configured to detect changes in signal levels at an input-and-output end of the at least one of the plurality of the basic elements and a data storage section configured to store a position data corresponding to the changes of the signal levels.

Additional advantages and novel features of the invention will be set forth in part in the description that follows, and in part will become more apparent to those skilled in the art upon examination of the following or upon learning by practice of the invention. The term exemplary is used throughout the specification as meaning serving as an example, instance, or illustration.

### BRIEF DESCRIPTION OF THE DRAWINGS

FIG. 1 illustrates an exemplary model basic element;

FIG. 2 illustrates an exemplary operation and an exemplary current consumption value of a basic element;

FIG. 3 illustrates an exemplary model basic element;

FIG. 4 illustrates an exemplary operation and an exemplary current consumption value of a basic element;

FIG. 5 illustrates an exemplary model basic element;

FIG. 6 illustrates an exemplary operation and an exemplary current consumption value of a basic element;

FIG. 7 illustrates an exemplary logical simulation system;

FIG. 8 illustrates an exemplary logical simulation system;

FIG. 9 illustrates an exemplary logical simulation;

FIG. 10 illustrates an exemplary logical simulation system;

FIG. 11 illustrates an exemplary logical simulation;

FIG. 12 illustrates an exemplary logical simulation; and

FIG. 13 illustrates an exemplary logical simulation system.

### DESCRIPTION OF EMBODIMENTS

A logical simulation system reads and stores test pattern data and data of a logic circuit of an IP core and checks for a change in the signal state on the basic element level in the IP core in order to analyze current consumption. The current consumption volume of the entire basic element is calculated based on the change in the signal state in the basic element level in the IP core.

An encrypted IP core may be provided to, for example, a customer who performs a logical simulation based on the encrypted IP core. When the simulation is performed based on the encrypted IP core, the change in the signal state in the basic element level in the IP core may not be analyzed.

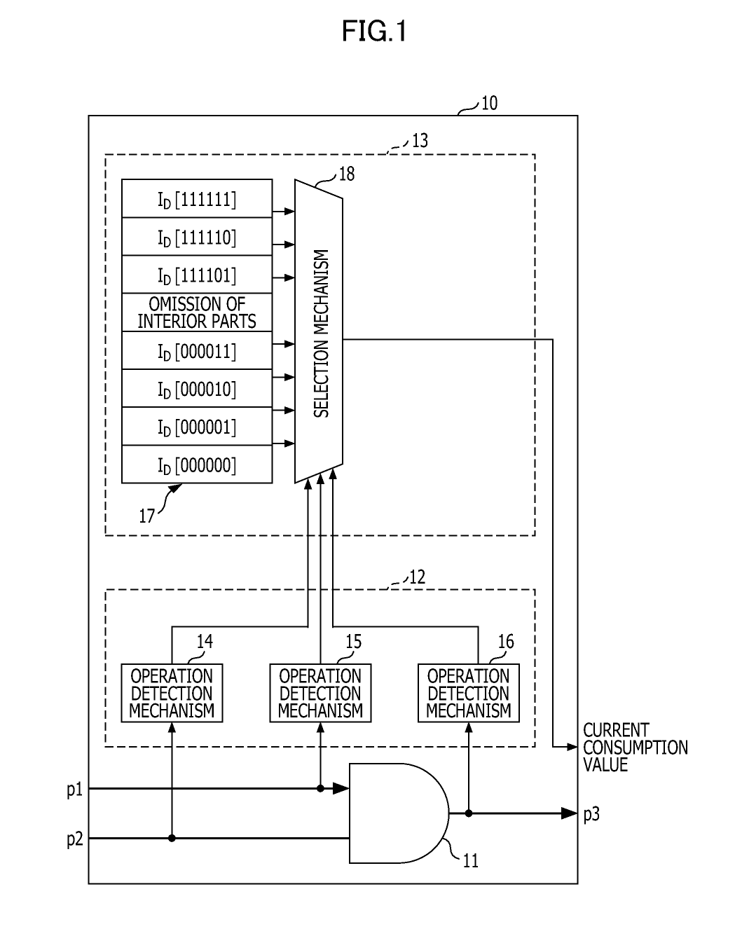

FIG. 1 illustrates an exemplary model of a basic element. The basic model 10 may be embedded in net data. The basic element 10 illustrated in FIG. 1 is described in a specified hardware description language and operates as a basic element during a logical simulation of a circuit described in a netlist by a calculator. The basic element includes a basic cell provided in a logic circuit. The basic cell includes, for example, an AND cell, an OR cell, a flip-flop cell, and so forth. The basic element 10 may be prepared as a library in a verilog simulator.

The basic element 10 includes a logic operation unit 11, a change detection unit 12, and a data storage unit 13. The logic operation unit 11 stipulates a logic operation of the basic element 10. For example, in the logic operation unit 11, it is described that a signal obtained by AND operation of signals transmitted from input ends p1 and p2, which are the basic element 10 of an AND circuit, is transmitted from an output end p3. The change detection unit 12 detects a change in the signal level at each of the input ends p1 and p2, and the output end p3. The change detection unit 12 includes operation detection mechanisms 14, 15, and 16 that respectively correspond to the two input ends p1 and p2, and the single output end p3. Data of the positions corresponding to combinations of changes in the signal levels is read from the data storage unit 13 including a data array 17 and a selection mechanism 18. The data array 17 may include data of a current consumption value.

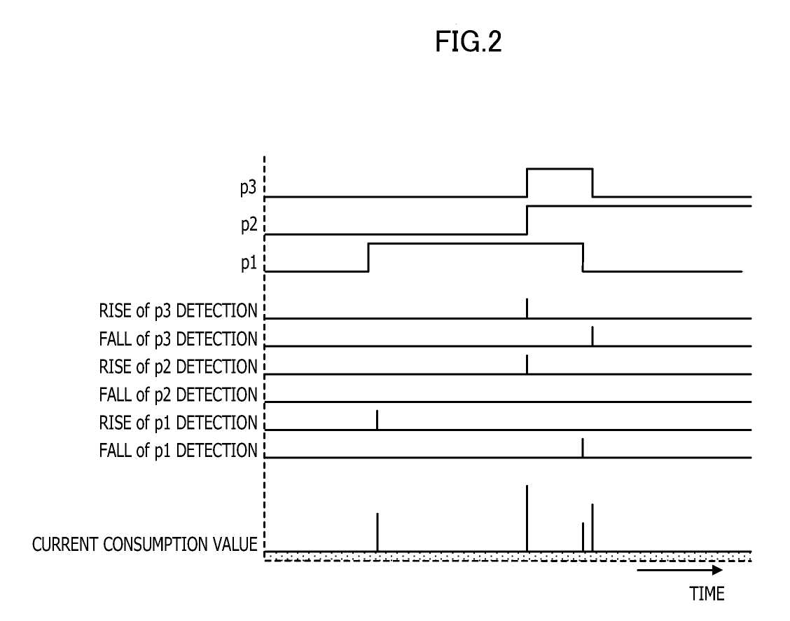

FIG. 2 illustrates an exemplary operation and an exemplary current consumption value of a basic element. The basic element illustrated in FIG. 2 may be the basic element 10 illustrated in FIG. 1. When signal waveforms illustrated in FIG. 2 are applied to the respective input ends p1 and p2 of the AND circuit illustrated in FIG. 1, a signal waveform illustrated in FIG. 2 is externally transmitted from the output end p3. The operation detection mechanism 14 illustrated in FIG. 1 detects a rising change and falling change in the signal waveform of the input end p2 respectively. The operation detection mechanism 15 illustrated in FIG. 1 detects a rising change and a falling change of the input end p1 respectively. The operation detection mechanism 16 illustrated in FIG. 1 detects a rising change and a falling change of the output end p3 respectively.

The selection mechanism 18 illustrated in FIG. 1 selects data included in the data array 17 stored based on the changes detected bay the operation detection mechanisms 14 to 16. The data in the data array 17 is selected based on the rising changes and the falling changes of the input ends p1 and p2, and the output end p3. For example, values 1 indicating detection and 0 indicating non-detection are assigned to each of six events, “rising of p3”, “falling of p3”, “rising of p2”, “falling of p2”, “rising of p1”, and “falling of p1” so that a six-bit pattern “b6, b5, b4, b3, b2, and b1” is obtained. The six-bit pattern is used as the read address (an array number and/or indices) of the data array 17, and storage value of the data array 17 corresponding to the bit pattern is read. The read data, for example, the current consumption value is illustrated at the low end of FIG. 2.

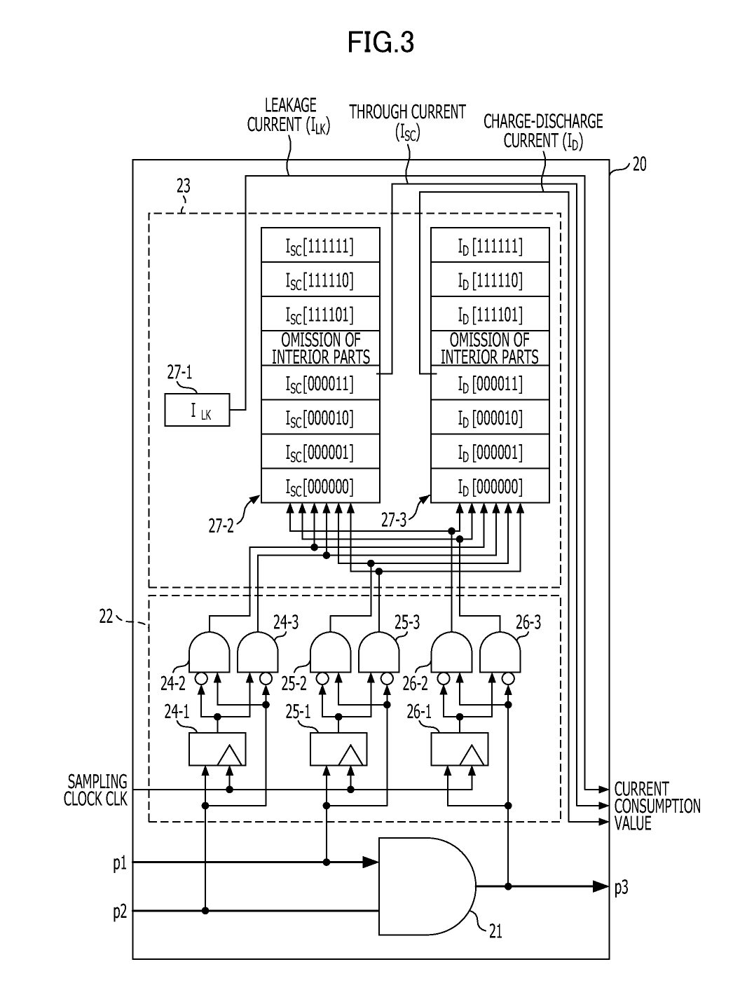

FIG. 3 illustrates an exemplary model of basic element. The basic element 20 includes a logic operation unit 21, a change detection unit 22, and a data storage unit 23. The functions and operations of the logic operation unit 21, the change detection unit 22, and the data storage unit 23 are substantially the same or similar to those of the logic operation unit 11, change detection unit 12, and data storage unit 13 illustrated in FIG. 1. In the basic element 20, the signal change may be detected in synchronization with a sampling clock signal CLK to support for a digital calculator. Further, three current values corresponding to a leakage current, a through current, and a charge-discharge current may be transmitted from the basic element 20.

In the change detection unit 22, each of a flip-flop 24-1, an AND circuit 24-2, and an AND circuit 24-3 detects the signal change at the input end p2. Each of a flip-flop 25-1, an AND circuit 25-2, and an AND circuit 25-3 detects the signal change at the input end p1. Each of a flip-flop 26-1, an AND circuit 26-2, and an AND circuit 26-3 detects the signal change at the input end p3. One of inputs of each of the AND circuits 24-2, 24-3, 25-2, 25-3, 26-2, and 26-3 is a negative logic and the other is a positive logic. The flip-flop retains a signal at one-previous clock cycle and the AND circuit detects a difference between the signal at one-previous clock cycle and the signal at a current clock cycle.

The data storage unit 23 includes a leakage current value-register 27-1, a through current value-data array 27-2, and a charge-discharge current value-data array 27-3. The leakage current value-register 27-1 stores current value of a leakage current flowing through an AND circuit indicated by the logic operation unit 21. Since the leakage current keeps flowing irrespective of the signal change, a certain value being independent from the signal change may be stored. The through current value-data array 27-2 includes a through current value which momentarily flows from a power voltage-side to a ground voltage-side in a complementary metal oxide semiconductor (CMOS) circuit when a signal is changed. Since the through current value depends on a signal change, a data array ISC, which stores a current value corresponding to the signal level change, may be provided. The charge-discharge current value-data array 27-3 stores a discharge current value discharged from wiring to the ground when the signal is changed from a high level to a low level and a charge current value charged from a power supply to the wiring when the signal is changed from the low level to the high level. Since the charge-discharge current depends on the signal change, a data array ID, which stores a current value corresponding to the signal change, may be used. In FIG. 3, the leakage current, the through current, and the charge-discharge current are externally transmitted separately.

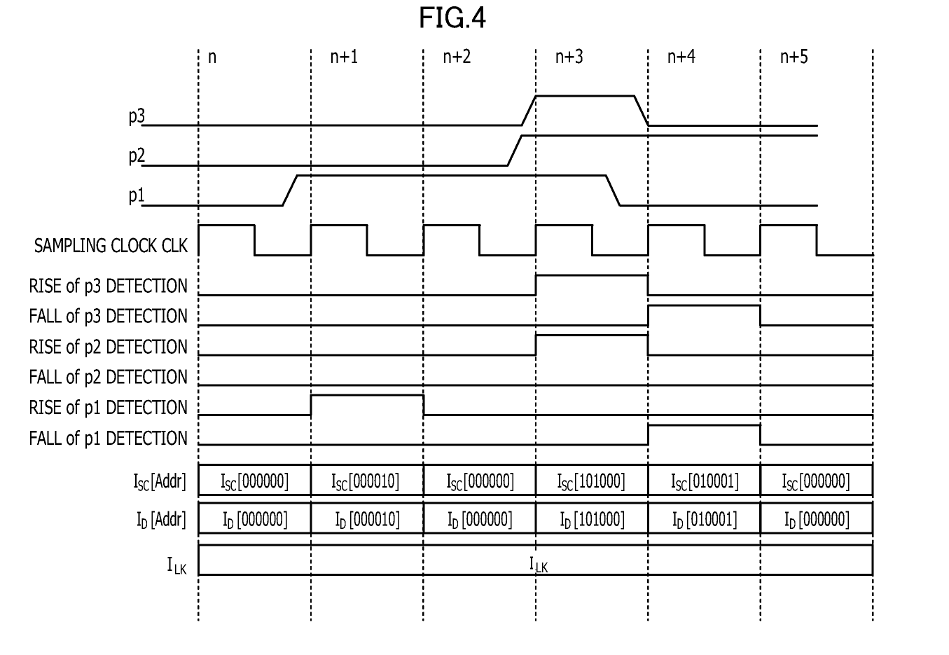

FIG. 4 illustrates an exemplary operation and an exemplary current consumption value of a basic element. The basic element may be the basic element 20 illustrated in FIG. 3. When signal waveforms illustrated in FIG. 4 are applied to the respective input ends p1 and p2 of the AND circuit indicated by the logic operation unit 21 illustrated in FIG. 3, a signal waveform illustrated in FIG. 4 is externally transmitted from the output end p3. Rising changes and falling changes in the signal waveforms of the input ends p1 and p2, and the output end p3 are separately detected in synchronization with a rise edge of a sampling clock signal CLK. FIG. 4 illustrates a result of detecting the rising change and the falling change of the waveforms of the input ends p1 and p2, and the output end p3 in synchronization with the clock signal CLK.

Since, in each of the clock cycles n, n+2, and n+5, the events “rising of p3”, “falling of p3”, “rising of p2”, “falling of p2”, “rising of p1”, and “falling of p1” may be [0, 0, 0, 0, 0, 0], a through current ISC [000000] and the charge-discharge current ID [000000] are transmitted. For example, since, in the clock cycle n+1, the events “rising of p3”, “falling of p3”, “rising of p2”, “falling of p2”, “rising of p1”, and “falling of p1” may be [0, 0, 0, 0, 1, 0], a through current ISC [000010] and a charge-discharge current ID [000010] are transmitted. Operations at the other clock cycles are substantially the same as the previous operations. A storage value ILK in the leakage current value-register 27-1 may be output as a leakage current.

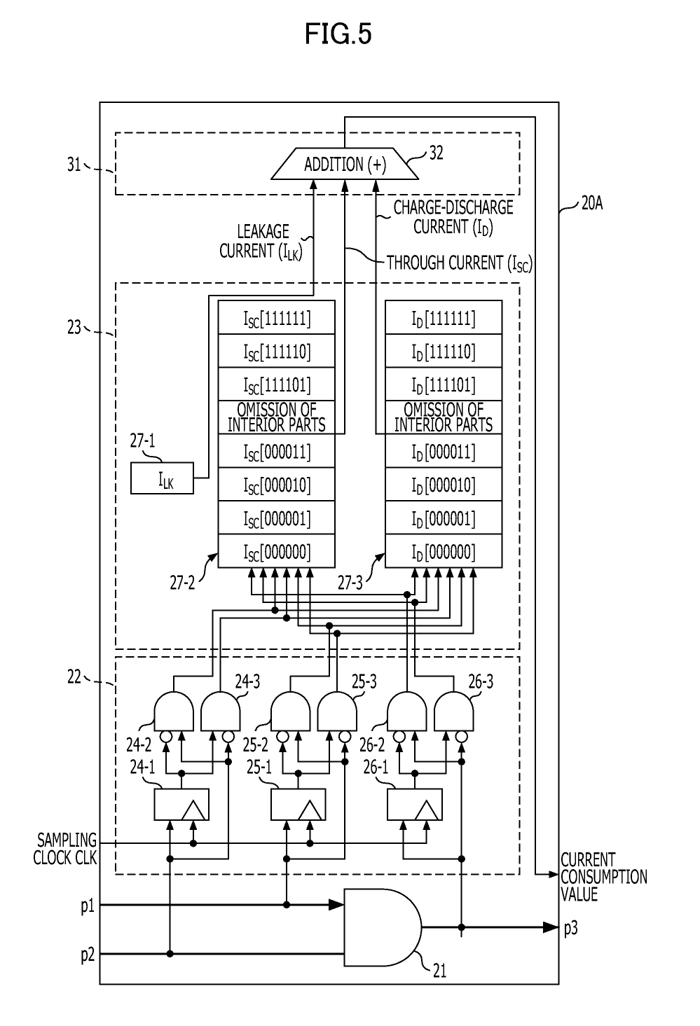

FIG. 5 illustrates an exemplary model of a basic element. The basic element may be a modification of the basic element 20 illustrated in FIG. 3. In FIG. 5, elements which are substantially the same as those illustrated in FIG. 3 are designated by the same reference numerals, and the descriptions thereof are omitted or reduced. A basic element 20A illustrated in FIG. 5 includes a calculation unit 31 having an adder 32 which adds the leakage current value, the through current value, and the charge-discharge current value stored in the data storage unit 23 to obtain the sum-total of the three current values. The sum-total of the three current values is output from the basic element 20A.

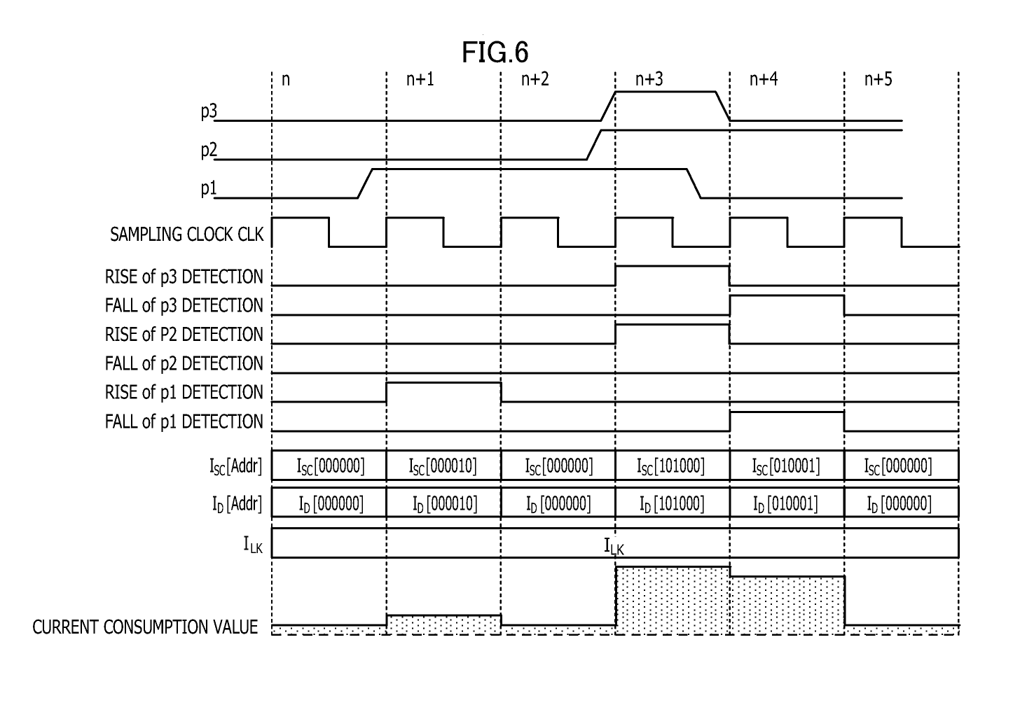

FIG. 6 illustrates an exemplary operation and an exemplary current consumption value of a basic element. The basic element illustrated in FIG. 6 may be the basic element illustrated in FIG. 5. As illustrated in FIG. 4, the through current ISC and the charge-discharge current ID, which correspond to the result of detecting the events “rising of p3, falling of p3, rising of p2, falling of p2, rising of p1, and falling of p1” in each of the clock cycles, are obtained. A fixed value ILK is obtained as the leakage current. In FIG. 6, the sum total of the through current ICS, the charge-discharge current ID, and the leakage current ILK is output as the current consumption value.

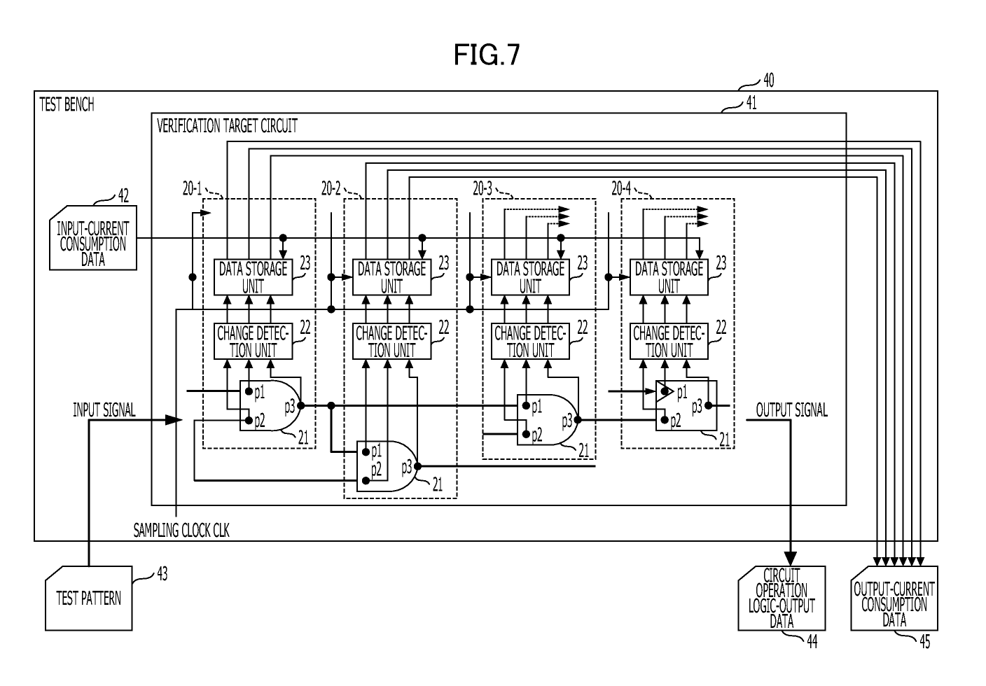

FIG. 7 illustrates an exemplary logical simulation system. In FIG. 7, elements which are substantially the same or similar to elements illustrated in FIG. 3 are designated by the same reference numerals, and the descriptions thereof are omitted or reduced. A computer including a computation unit and a memory storing a logical simulation program executes the logical simulation program using the computation unit.

The logical simulation system includes a test bench 40 and a verification target circuit 41 to be verified. The verification target circuit 41 may be a logical model of a circuit to be verified. The logical model includes the netlist of the verification target circuit 41 and information used to execute a simulation of the basic element or the like, and performs logic operations of the verification target circuit 41. Test bench 40 describes information for starting, controlling, and stopping the logical simulation of the verification target circuit 41. The logical simulation system may be, for example, the verilog simulator. The logical simulation system may not execute an analog operation simulation and may verify a part relating to the logic operations.

The verification target circuit 41 includes basic elements 20-1, 20-2, 20-3, and 20-4, and includes at least two basic elements that are coupled to each other according to the netlist of the circuit. For the sake of simplification, FIG. 7 illustrates the four basic elements 20-1 to 20-4. However, the verification target circuit 41 may include four or more basic elements. Each of the basic elements 20-1 to 20-4 may correspond to, for example, the basic element 20 illustrated in FIG. 3, and includes the logic operation unit 21, the change detection unit 22, and the data storage unit 23. The logic operation unit 21 stipulates logic operations of the basic elements. The change detection unit 22 detects a change in the signal level at each of the input ends p1 and p2, and the output end p3 of the basic element. The positions corresponding to changes in the signal levels are read from the data storage unit 23.

The logical simulation system executes the logical simulation of the circuit using the verification target circuit 41 which is the logical model. Input-current consumption data 42 is stored in the data storage unit 23 of each of the basic elements of the verification target circuit 41. The input-current consumption data 42 may correspond to the current consumption value of each of the basic elements which are calculated by a circuit simulator or theoretical calculations based on the netlist of the verification target circuit 41 and information about the resistance and capacity of wiring. The consumption current value includes the through current value, the charge-discharge current value, and the leakage current value. For the through current value and the charge-discharge current value, a plurality of values are set based on changes in the signal levels at the input ends and the output end of each of the basic elements. When each of the basic elements 20-1 to 20-4 is independently provided as, for example, a library, the current value data may not be stored in the data storage unit 23. After the basic element is arranged in the circuit based on the netlist, the input-current consumption data 42 according to the wiring condition where the basic element is arranged is stored in the data storage unit 23 at the place.

After the input-current consumption data 42 is stored, the logic operation of the verification target circuit 41 is started via the test bench 40. Test pattern data 43 is supplied to the verification target circuit 41 as circuit input data. The circuit input data is processed based on the logic operation performed by the verification target circuit 41 in synchronization with the sampling clock signal CLK. Logic data is generated as circuit output data and is output as circuit operation logic-output data 44. The output-current consumption data 45 corresponding to the data read from the data storage unit 23 is output as a result of the logical simulation. The output-current consumption data 45 may be the through current value data, the charge-discharge current value data, and the leakage current value data that are output from each of the basic elements 20-1 to 20-4. The current value corresponding to the through current ISC, the charge-discharge current ID, and the leakage current ILK that are illustrated at the low end of FIG. 4 may be supplied to each of the basic elements 20-1 to 20-4.

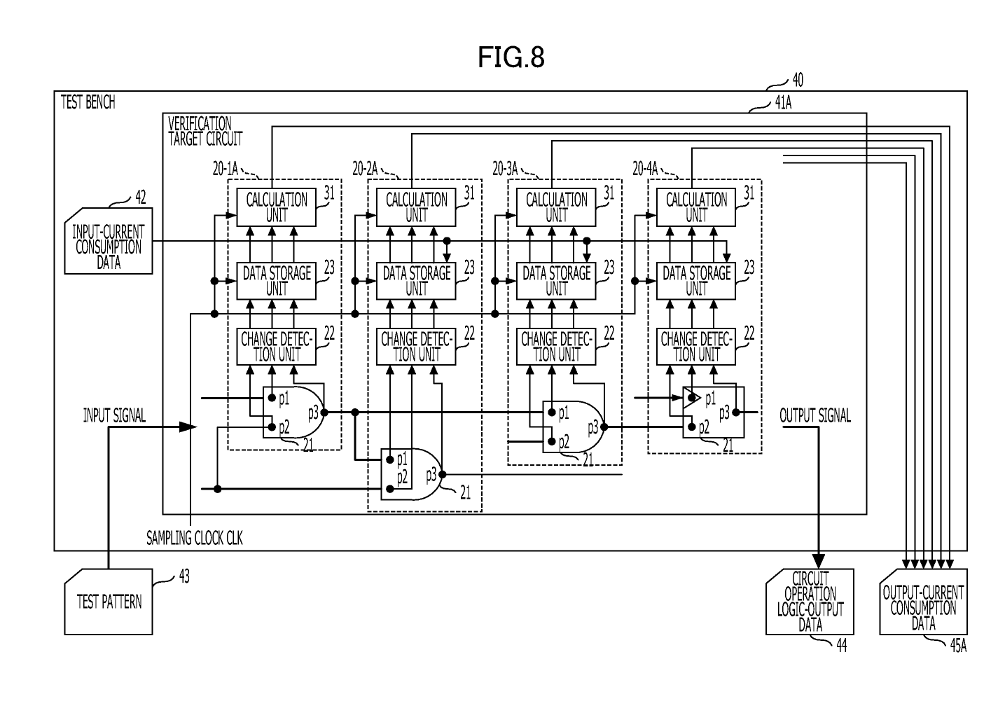

FIG. 8 illustrates an exemplary logical simulation system. The logical simulation system in FIG. 8 may perform the logical simulation for the basic element illustrated in FIG. 5. In FIG. 8, elements which are substantially the same or similar to elements illustrated in FIGS. 5 and 7 are designated by the same reference numerals, and the descriptions thereof are omitted or reduced. The logical simulation system illustrated in FIG. 8 executes the logical simulation using a verification target circuit 41A as a logical model. The verification target circuit 41A includes basic elements 20-1A, 20-2A, 20-3A, and 20-4A. Each of the basic elements 20-1A to 20-4A may correspond to the basic element 20A illustrated in FIG. 5, and includes the logic operation unit 21, the change detection unit 22, the data storage unit 23, and the calculation unit 31. Output current consumption data 45A may correspond to a sum total of the through current value, the charge-discharge current value, and the leakage current value that are output from each of the basic elements 20-1A to 20-4A. The current value corresponding to the current consumption value illustrated at the low end of FIG. 6 is output from each of the basic elements 20-1A to 20-4A.

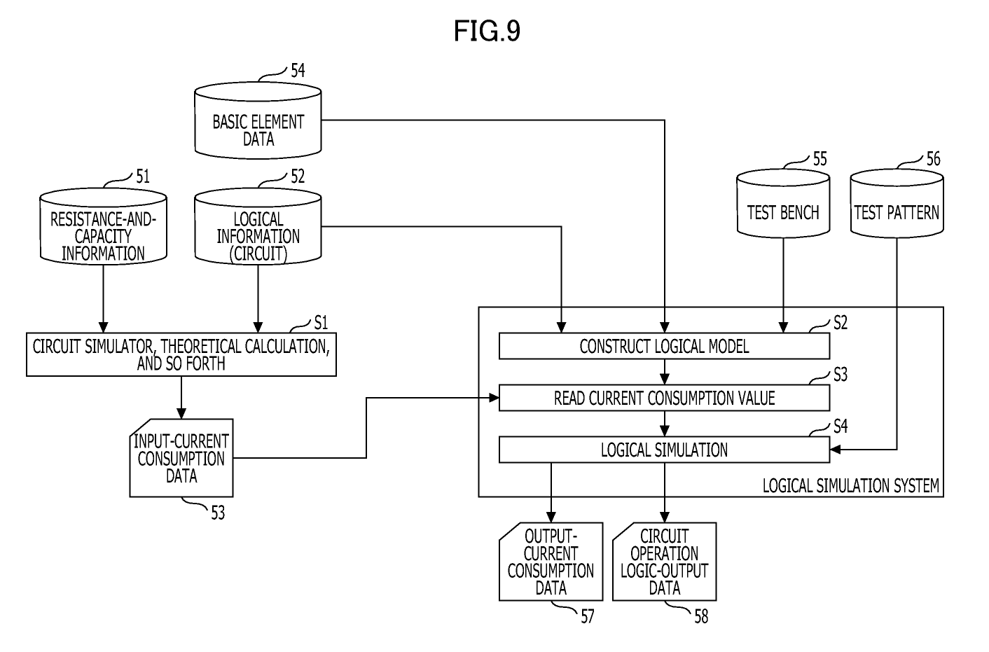

FIG. 9 illustrates an exemplary logical simulation. At operation S1, the current consumption value of each of the basic elements, such as input-current consumption data 53 is obtained by a circuit simulator or theoretical calculations based on resistance-and-capacity information 51 and logical information 52. The resistance-and-capacity information 51 is extracted based on data regarding the arrangement and wiring of the verification target circuit 41A. The logical information 52 may be, for example, the netlist of the verification target circuit 41A. The input current consumption data 53 may correspond to the input-current consumption data 42 illustrated in each of FIGS. 7 and 8, for example.

At operation S2, the logical model is constructed using a test bench 55 based on the logical information 52 and basic element data 54. The basic element data 54 at least describes the logic operation unit, the change detection unit, and the data storage unit of the basic element including, for example, an AND cell, an OR cell, an inverter, a NAND cell, and a flip-flop. At operation S3, the input-current consumption data 53 is read and stored in the logical simulation system. The current consumption data corresponding to the input current consumption data 53 is stored in the data storage unit of the basic element of the logical model constructed at the operation S2. At operation S4, the logical simulation of the verification target circuit 41A is performed based on the logical model constructed at operation S2. Test pattern data 56 is applied to the logical model as input data, and the logical model operates in synchronization with the clock signal. Output-current consumption data 57 and circuit operation logic-output data 58 are output as a result of the logical simulation. The output-current consumption data 57 and the circuit operation logic-output data 58 may respectively correspond to the output-current consumption data 45 and/or 45A, and the circuit operation logic-output data 44 that are illustrated in FIGS. 7 and 8.

In the logical simulation illustrated in FIG. 9, data of currents consumed at each of the basic elements is obtained using the logical simulation. Logical output data and current consumption data as a result of the logical simulation.

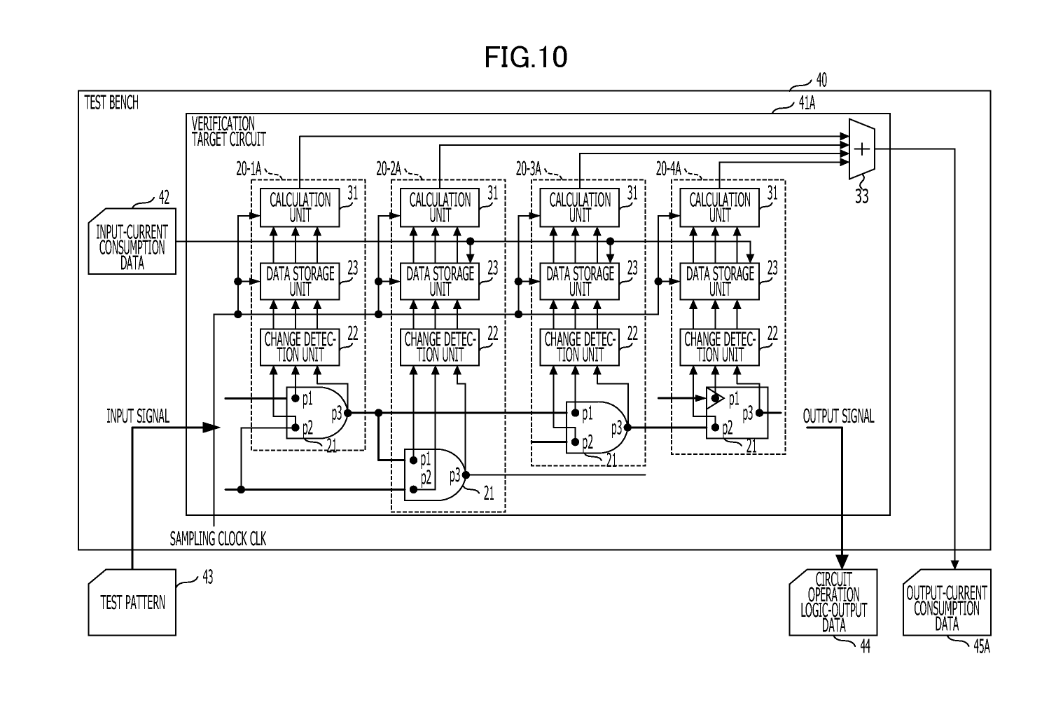

FIG. 10 illustrates an exemplary logical simulation system. In FIG. 10, elements which are substantially the same or similar to those illustrated in FIG. 8 are designated by the same reference numerals, and the descriptions thereof are omitted or reduced. In the logical simulation system illustrated in FIG. 10, a logical simulation is performed using a verification target circuit 41B as a logical model. The verification target circuit 41B includes the verification target circuit 41A and a sum-total calculation unit 33. The sum-total calculation init 33 calculates the sum total of the output current consumption values of the basic elements 20-1A to 20-4A that are included in the verification target circuit 41B. The sum-total calculation unit 33 outputs the sum total of currents consumed by the entire verification target circuit 41B as output-current consumption data 45C.

The sum-total calculation unit 33 calculates the value of the sum total of currents consumed by the verification target circuit 41B. However, the sum-total calculation unit 33 may calculate the value of the sum total of currents consumed by at least one circuit block included in the verification target circuit 41B. For example, the verification target circuit 41B may include many basic elements other than the basic elements 20-1A to 20-4A. The sum-total calculation unit 33 may calculate the value of the sum total of currents consumed by a circuit block including the basic elements 20-1A to 20-4A. The value of currents consumed by each of different basic elements may be output and the value of the sum total of currents consumed by the basic elements may be output. Further, the sum-total current consumption value data may be output in groups of a plurality of the circuit blocks.

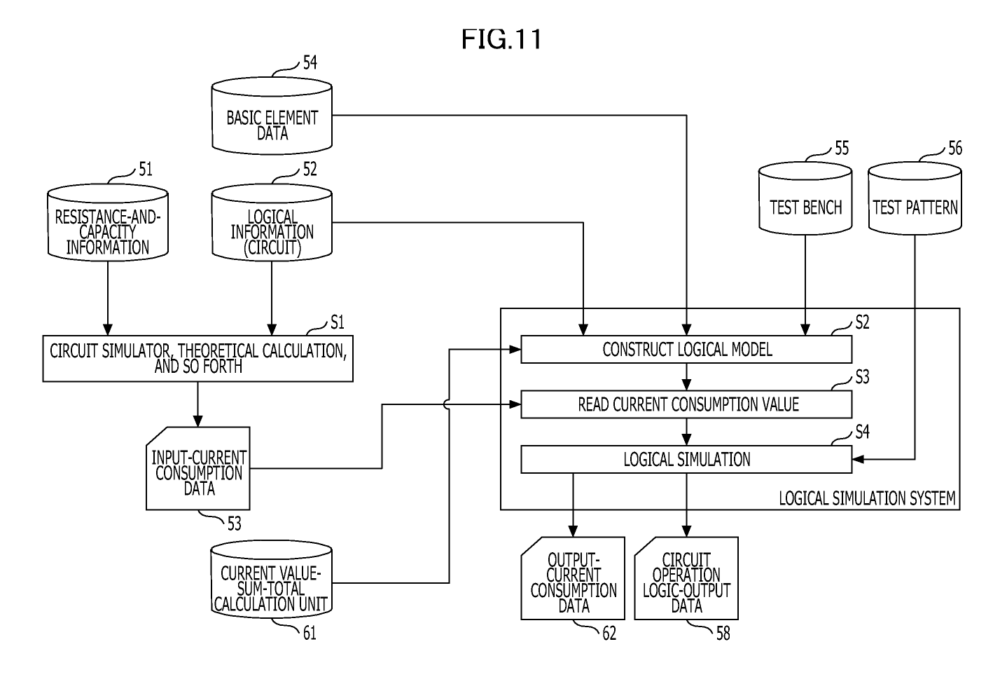

FIG. 11 illustrates an exemplary logical simulation. In the logical simulation illustrated in FIG. 11, the logical simulation is performed after adding a sum-total calculation unit to the verification target circuit. In comparison with the simulation method illustrated in FIG. 9, an operation at operation S2 of the logical simulation illustrated in FIG. 11 may be different. At operation S2 illustrated in FIG. 11, a current value-sum-total calculation unit 61 is included in the logical model when a logical model is constructed based on the logical information 52 and the basic element data 54. The current value-sum-total calculation unit 61 may correspond to the sum-total calculation unit 33 illustrated in FIG. 10. Output-current consumption data 62 obtained as a result of the logical simulation at an operation S4 may correspond to the output-current consumption data 45C illustrated in FIG. 10.

The output current consumption data 62 may be the sum total of the current values of the entire verification target circuit or the sum total of the current values of a circuit block part which is a part of the verification target circuit. In the latter case, the value of currents consumed by each of the basic elements other than the circuit block part may be calculated and the sum total of currents consumed by a part other than the above-described circuit block part may be calculated. The sum total of currents consumed by the plurality of circuit blocks may be calculated.

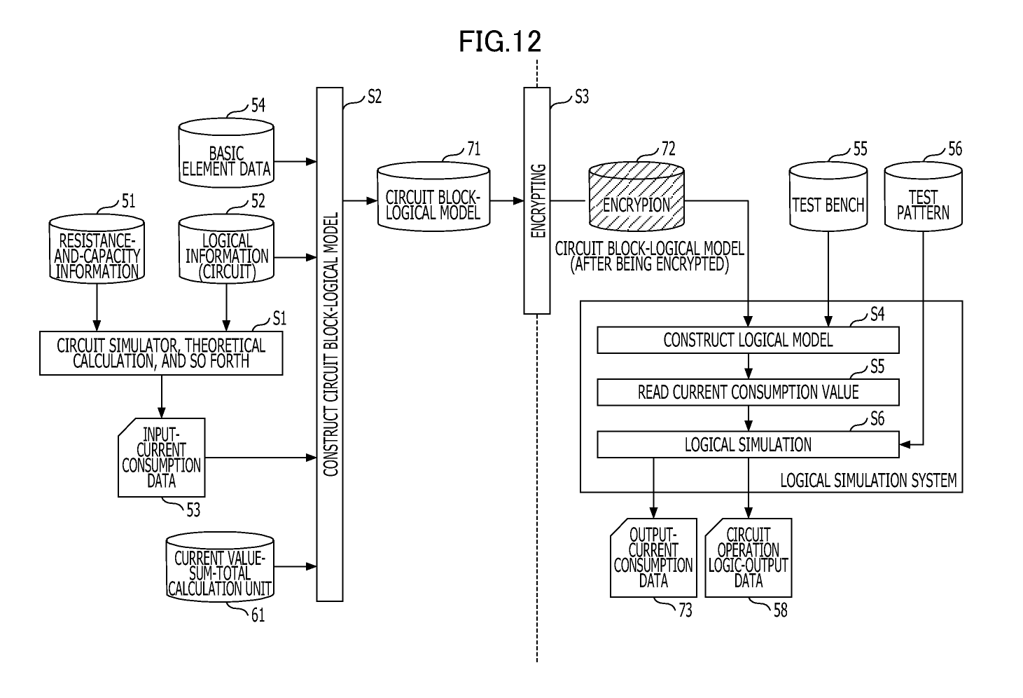

FIG. 12 illustrates an exemplary logical simulation. In FIG. 12, elements which are substantially the same or similar to elements illustrated in FIGS. 9 and 11 are designated by the same reference numerals, and the descriptions thereof are omitted or reduced.

At operation S1, the current consumption value of each of the basic elements, such as the input-current consumption data 53 is obtained by a circuit simulator or theoretical calculations based on the resistance-and-capacity information 51 and the logical information 52. At operation S2, circuit block-logical model 71 is constructed based on the logical information 52, the basic element data 54, the input-current consumption data 53, and the current value-sum-total calculation unit 61. The current data corresponding to the input-current consumption data 53 is stored in the data storage unit of each of the basic elements of the circuit block-logical model 71. At operation S3, the circuit block-logical model 71 is encrypted so that an encrypted-circuit block-logical model 72 is generated. For example, encrypted data of part of the basic elements 20-1A to 20-4A and the sum-total calculation unit 33 illustrated in FIG. 10 may correspond to the encrypted-circuit block-logical model 72. The current consumption value corresponding to the input-current consumption data 53 stored in the data storage unit 23 of each of the basic elements 20-1A to 20-4A is also encrypted.

The encrypted data may be data that may be read by the logical simulation system and may not be analyzed by a person. For example, text information is converted into binary information that may be analyzed by the logical simulation system so that the text information is encrypted. The text information may be encrypted by an encrypting function of the logical simulation system. Since the circuit block is encrypted by the encrypting function, the logical simulation system performs a logical simulation for the encrypted circuit block data. However, the logical simulation system does not provide information about the internal configuration of the circuit block.

At operation S4, a logical model is constructed using a test bench 55 based on the encrypted-circuit block-logical model 72 and the basic element data 54. For example, operations S1 to S3 may be performed by a company that developed an IP core, and the encrypted-circuit block-logical model 72 may be provided from the company to a customer as the IP core. The customer may incorporate the provided IP core into a circuit so that a logical model of a circuit including the encrypted-circuit block-logical model 72 is constructed. Since the internal configuration or the like of the encrypted-circuit block-logical model 72 may not be analyzed, data of the internal configuration of the circuit block may not be leaked to the customer.

At operation S5, the input-current consumption data is read and stored in the logical simulation system. The corresponding current consumption data is stored in a part where the current consumption value data is not stored. The part may be included in the data storage unit of each of the basic elements of the logical model constructed at operation S4. The part may be a part other than the encrypted-circuit block-logical model 72. At operation S6, the logical simulation of the verification target circuit is executed based on the logical model constructed at operation S4. The test pattern data 56 is applied to the logical model as input data and the logical model operates in synchronization with the clock signal so that the logic operation of the verification target circuit is simulated. As a result of the logical simulation, output-current consumption data 73 and circuit operation logic-output data 58 are output.

The output-current consumption data 73 may be current data including the sum total of the current values of the encrypted circuit block. The current value consumed by each of the basic elements other than the circuit block part may be calculated or the sum total of the current consumption values of a part other than the circuit block part may be calculated. Further, the sum total of the current consumption values of each of a plurality of circuit blocks may be calculated.

The current consumption value read from the basic element may be a current consumption value within one sampling clock cycle. The current value stored in the data storage unit may be a current value obtained by averaging the current values in the sampling clock cycle. In terms of the calculation precision, the sampling clock cycle may be short. The precision of the current consumption value read from the basic element may depend on the sampling clock cycle. For example, when a signal at the end is changed from a low level to a high level and is changed from the high level to the low level within a single clock cycle, the change may not be detected as the end change in the previous basic element. Since the sampling clock cycle is reduced, a current value close to the current consumption value of an actual circuit may be output.

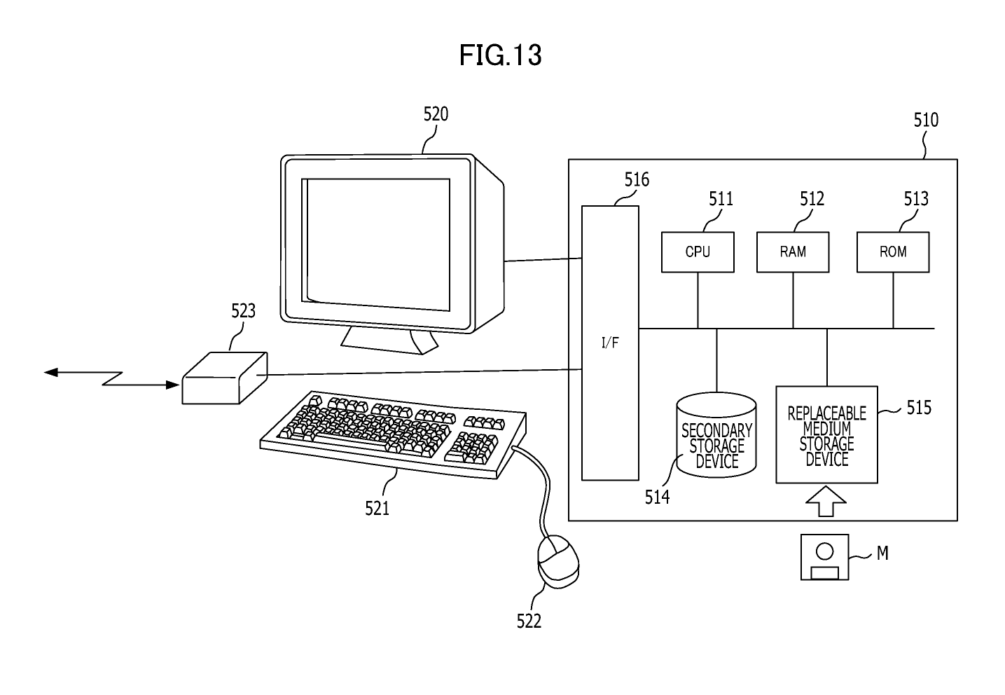

FIG. 13 illustrates an exemplary logical simulation system.

As illustrated in FIG. 13, a system executing a logical simulation includes, for example, a personal computer, an engineering workstation, and so forth. The system illustrated in FIG. 13 includes a computer 510 and a display device 520, a communication device 523, and an input device that are coupled to the computer 510. The input device includes, for example, a keyboard 521 and a mouse 522. The computer 510 includes a CPU 511, a RAM 512, a ROM 513, a secondary storage device 514 such as a hard disk, a replaceable medium storage device 515, and an interface 516.

Each of the keyboard 521 and the mouse 522 is used as an interface between a user and the system. For example, various commands for operating the computer 510 or user responses to requested data is input. The display device 520 displays, for example, a processing result of the computer 510, and displays data for communicating with the user operating the computer 510. The communication device 523 communicates with a distant user and includes a modem, a network interface or the like.

A method of a logical simulation may be provided as a computer program that is executed by the computer 510. The computer program may be stored in a storage medium M that may be inserted into the replaceable medium storage device 515, and loaded from the storage medium M to the RAM 512 or the secondary storage device 514 via the replaceable medium storage device 515. The computer program may be stored in a storage medium (not shown) provided at a distant location, and loaded from the storage medium to the RAM 512 or the secondary storage device 514 via the communication device 523 and the interface 516.

The CPU 511 loads the program from the storage medium M, the storage medium at the distant location, or the secondary storage device 514 to the RAM 512 based on a program execution instruction issued from the user via the keyboard 521 and/or the mouse 522. The CPU 511 executes the program loaded to the RAM 512 using a free storage space of the RAM 512 as a work area, and performs processing while communicating with the user as appropriate. The ROM 513 may store a control program for controlling basic operations of the computer 510.

The computer 510 may execute the above-described computer program and execute the above-described logical simulation.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. The media described above are non-transitory media.

Example embodiments of the present invention have now been described in accordance with the above advantages. It will be appreciated that these examples are merely illustrative of the invention. Many variations and modifications will be apparent to those skilled in the art.

1. A program that simulates a netlist data including a plurality of basic elements using a computer, comprising:
a logic operation section configured to stipulate a logic operation of at least one of the plurality of the basic elements;
a change detection section configured to detect changes in signal levels at an input-and-output end of the at least one basic element; and
a data storage section configured to store a position data corresponding to the changes of the signal levels.

2. The program according to claim 1, further comprising:
a sum-total calculation unit configured to calculate a sum total of the position data for the plurality of basic elements.

3. The program according to claim 2, wherein at least a part of the netlist data is encrypted.

4. A logical simulation method executed by a computer, comprising:
stipulating a logic operation of at least one of a plurality of basic elements;
detecting changes in signal levels at an input-and-output end of the at least one basic element;
reading a position data corresponding to the changes in the signal level from a data storage section;
reading a netlist data for a circuit including the at least one basic element;
constructing a logical model of the circuit based on the netlist data; and
executing a logical simulation for the logical model.

5. The logical simulation method according to claim 4, further comprising:
reading current consumption information of the plurality of the basic elements; and
storing the current consumption information in the data storage section.

6. The logical simulation method according to claim 4, further comprising:
outputting a result of the logical simulation,
wherein the result includes a sum total of the position data read from the data storage section.

7. The logical simulation method according to claim 5, further comprising:
constructing a first logical model of the circuit based on the plurality of basic elements,
encoding at least a part of the circuit, and
constructing a second logical model including the encrypted part of the circuit.

8. A logical simulation system, comprising:
a computation unit;
a memory configured to store a program for a logical simulation;
a logic operation unit configured to stipulate a logic operation of at least one of a plurality of basic elements;
a change detection unit configured to detect changes in signal levels at an input-and-output end of the at least one basic element; and
a data storage unit configured to store position data corresponding the changes,
wherein a logical model of a circuit is constructed based on netlist data including the plurality of basic elements, and
wherein the logical simulation is executed based on the logical model.

9. The logical simulation system according to claim 8,
wherein the computation unit reads current consumption information of the plurality of the basic elements, and stores the data of the current consumption information in the data storage unit.

10. The logical simulation system according to claim 8, further comprising:
an output unit configured to output a result of the logical simulation,
wherein the result includes a sum total of the position data read from the data storage unit.

11. The logical simulation system according to claim 8,
wherein the netlist data includes an encrypted circuit, and
wherein the computation unit constructs a logical model of a circuit including the encrypted circuit.
